(19) United States
(12) Patent Application Publication
(10) Pub. No.: US 2026/0312530 A1
(43) Pub. Date: Oct. 8, 2026

(54) FOLDABLE SOLAR TRACKER INTERFACE

(71) Applicant: APA SOLAR, LLC, Ridgeville Corners, OH (US)

(72) Inventors: Shawn Jeremy Ramey, Ney, OH (US); Joseph Von Deylen, Whitehouse, OH (US); Richard Alan Roth, Archbold, OH (US); Erik Steven Shinabery, Bryan, OH (US); Josh Von Deylen, Bryan, OH (US)

(21) Appl. No.: 19/641,068

(22) Filed: Apr. 7, 2026

Related U.S. Application Data
(60) Provisional application No. 63/784,411, filed on Apr. 7, 2025.

(51) Int. Cl. H02S 20/32

(52) U.S. Cl. CPC H02S 20/32

(57) ABSTRACT

A foldable A-frame assembly may include a mounting bracket formed from two panels connected through a top wall with a semicircular cutout. The mounting bracket may include pairs of apertures configured to receive fasteners for securing a first member and a second member to the mounting bracket. The assembly may be selectively positioned between multiple configurations through removal and reinsertion of fasteners. In a deployed configuration, the first and second members are positioned at predetermined angles to provide structural support for solar tracking equipment. In a folded configuration, achieved by removing lower fasteners, the members are positioned substantially parallel, allowing multiple assemblies to be arranged in an overlapping pattern with adjacent assemblies oriented 180 degrees relative to each other for improved shipping density. In an extended configuration, the members may be rotated outwardly until disposed on the same plane.

### CROSS-REFERENCE TO RELATED APPLICATIONS

This application claims the benefit of U.S. Provisional Application No. 63/784,411, filed on Apr. 7, 2025. The entire disclosure of the above application is incorporated herein by reference.

### FIELD

The present technology relates to foldable support structures for solar tracking systems and, more particularly, to configurable A-frame assemblies that may be selectively positioned between deployed and compact configurations to improve shipping density.

### INTRODUCTION

This section provides background information related to the present disclosure which is not necessarily prior art.

Solar tracking systems in the renewable energy sector rely heavily on mounting structures, with A-frame designs serving as important support components. Certain support structures utilizing A-frame configurations present significant logistical challenges that impact cost efficiency and deployment.

A-frame support structures may feature rigid triangular configurations that, while providing necessary stability for solar tracking equipment, create substantial inefficiencies in transportation and storage. These designs result in shipping containers and trucks reaching their volume capacity before achieving their weight limits, leading to increased transportation costs per unit. The inherent bulk of certain A-frame structures results in inefficient use of shipping space. This inefficiency increases direct shipping costs and contributes to higher carbon emissions through increased transportation requirements. Additionally, the fixed triangular shape of certain A-frame support structures creates challenges in warehousing and storage, requiring significant space allocation at distribution centers and installation sites.

The design of certain A-frame support structures fails to address the conflict between structural integrity and shipping efficiency. While certain designs attempt to modify the basic A-frame structure, these modifications often compromise the stability required for supporting solar tracking systems or involve complex assembly processes that increase installation and labor costs.

The logistics challenges associated with A-frame designs also have supply chain implications. Storage facilities must accommodate the inefficient shape of these structures, leading to increased warehouse costs. Installation sites face similar space constraints when receiving and storing components prior to assembly, potentially causing project complications and requiring additional staging areas.

There is accordingly a continuing need for an A-frame support structure that may maintain structural integrity while significantly improving shipping density and logistics efficiency. Desirably, such a structure would allow for compact transportation configuration without compromising the stability required for solar tracking applications, while also simplifying storage and reducing overall project costs through improved shipping efficiency.

### SUMMARY

In concordance with the instant disclosure, an A-frame support structure that may maintain structural integrity while significantly improving shipping density and logistics efficiency has surprisingly been discovered. The present technology includes articles of manufacture, systems, and processes that relate to configurable A-frame support structures for solar tracking systems with selectively deployable and foldable configurations that enable improved shipping density through removable bolt mechanisms.

In certain embodiments, an A-frame assembly is provided that may include a mounting bracket formed from two panels connected through a top wall, with each panel having top and bottom pairs of apertures. The mounting bracket may be configured to receive and secure a first member and a second member through a plurality of fasteners inserted through the aligned apertures. The first member and second member may be selectively positioned between a deployed configuration where the members are positioned at predetermined angles relative to the mounting bracket, a folded configuration where the members are positioned substantially parallel to one another, and an extended configuration where the members are rotated outwardly until substantially parallel. The selective positioning may be achieved through removal and reinsertion of the fasteners through different combinations of the aperture pairs.

In certain embodiments, an A-frame assembly for a solar tracking system comprises a mounting bracket including an I-beam and a pair of first channel members, a pair of longitudinal members, and a plurality of fasteners configured to couple the pair of longitudinal members to the mounting bracket. The I-beam has a pair of flanges spaced apart, with each first channel member coupled to one of the flanges. Each first channel member includes a plurality of first apertures, the plurality of first apertures including a first rotational aperture and a first fixation aperture. Each longitudinal member includes a first end, a second end, and a plurality of second apertures adjacent the first end, the plurality of second apertures including a second rotational aperture and a second fixation aperture. The plurality of fasteners cooperate with the plurality of first apertures and the plurality of second apertures to couple the pair of longitudinal members to the mounting bracket. The pair of longitudinal members are coupled to the mounting bracket using the plurality of fasteners in cooperation with the first rotational aperture and the second rotational aperture, where the pair of longitudinal members are configured to be selectively rotated between a folded configuration where the pair of longitudinal members are positioned substantially parallel to one another, an extended configuration where the pair of longitudinal members are positioned in line with one another, and a deployed configuration where the pair of longitudinal members are positioned at a predetermined angle between the folded configuration and the extended configuration. In the deployed configuration, the plurality of fasteners cooperate with the first fixation aperture and the second fixation aperture to fixedly couple the pair of longitudinal members relative to the mounting bracket, securing the A-frame assembly in its operational position for supporting solar tracking system components.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a front perspective view of an A-frame assembly according to one embodiment of the present disclosure, depicted in a deployed configuration, according to an embodiment of the present disclosure.

FIG. 2 is a front perspective view of an A-frame assembly according to one embodiment of the present disclosure, depicted in a deployed configuration, according to an embodiment of the present disclosure.

FIG. 3 is a top perspective view of the A-frame assembly of FIG. 1, according to an embodiment of the present disclosure.

FIG. 4 is a side perspective view of the A-frame assembly of FIG. 1, depicted in a folded configuration, according to an embodiment of the present disclosure.

FIG. 5 is a front view of the A-frame assembly of FIG. 4, according to an embodiment of the present disclosure.

FIG. 6 is a front elevational view of the A-frame assembly of FIG. 1, depicted with multiple A-frames arranged together in the extended position, according to an embodiment of the present disclosure.

FIG. 7 is a front elevational view of the A-frame assembly of FIG. 1, depicted with multiple A-frames arranged together in the folded configuration;

FIG. 8 is a close-up perspective view of an A-frame assembly according to one embodiment of the present disclosure.

FIG. 9 is a close-up perspective view of an A-frame assembly according to another embodiment of the present disclosure.

FIG. 10 is a front elevation view of an A-frame assembly in an extended configuration, according to an embodiment of the present disclosure.

FIG. 11 is a front elevational view of the A-frame assembly of FIG. 8, depicted with multiple A-frames arranged together in the folded configuration, according to an embodiment of the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps may be different in various embodiments, including where certain steps may be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1–10, or 2–9, or 3–8, it is also envisioned that Parameter X may have other ranges of values including 1–9, 1–8, 1–3, 1–2, 2–10, 2–8, 2–3, 3–10, 3–9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves shipping efficiency and logistics for solar tracking support structures by enabling A-frame assemblies to be reconfigured between deployed and folded positions through a simple bolt removal system, allowing more units to be transported before reaching trailer volume limitations while maintaining structural integrity for their intended application. The technology further improves storage capacity at warehouses and installation sites by providing a compact configuration option that reduces required storage space allocation for undeployed A-frame assemblies.

With reference to the Figures, an A-frame assembly 100 is shown. The A-frame assembly can include a mounting bracket 102 and a first member 104 and a second member 106. Each of the first member 104 and second member 106 may be pivotally attached to the mounting bracket 102 and extend from the mounting bracket 102. The mounting bracket 102 may be configured to support solar tracking equipment and provide attachment points for the first member 104 and second member 106.

The A-frame assembly 100 may advantageously be selectively positioned in multiple configurations including a deployed configuration, a folded configuration, and an extended configuration based on adjustable angles of the first member 104 and second member 106 relative to the mounting bracket 102. In the deployed configuration, the first member 104 and second member 106 may be positioned at predetermined angles to provide structural support to a solar tracker (not shown). In the folded configuration and the extended configuration, the first member 104 and second member 106 may be positioned to reduce the overall profile and/or volume of the assembly 100 for improved shipping density.

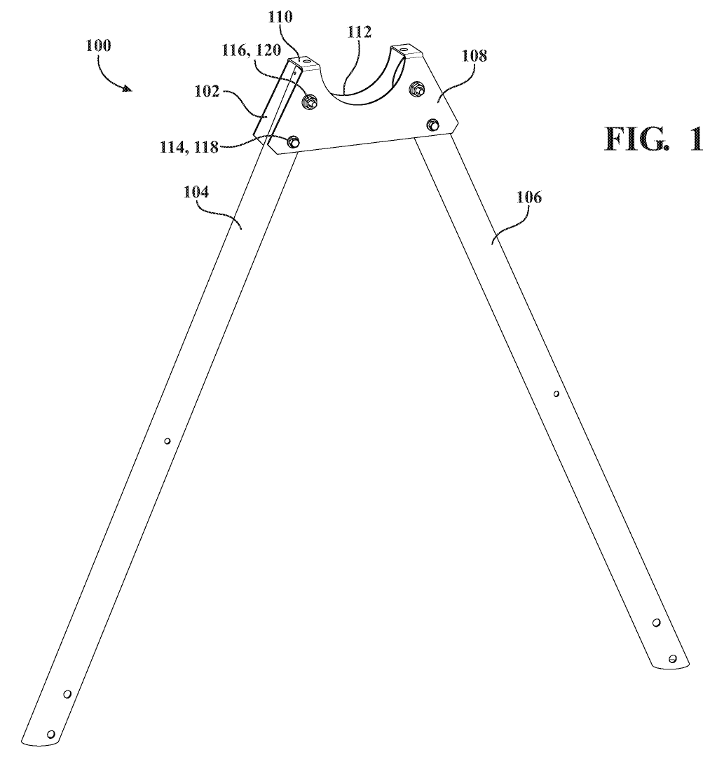

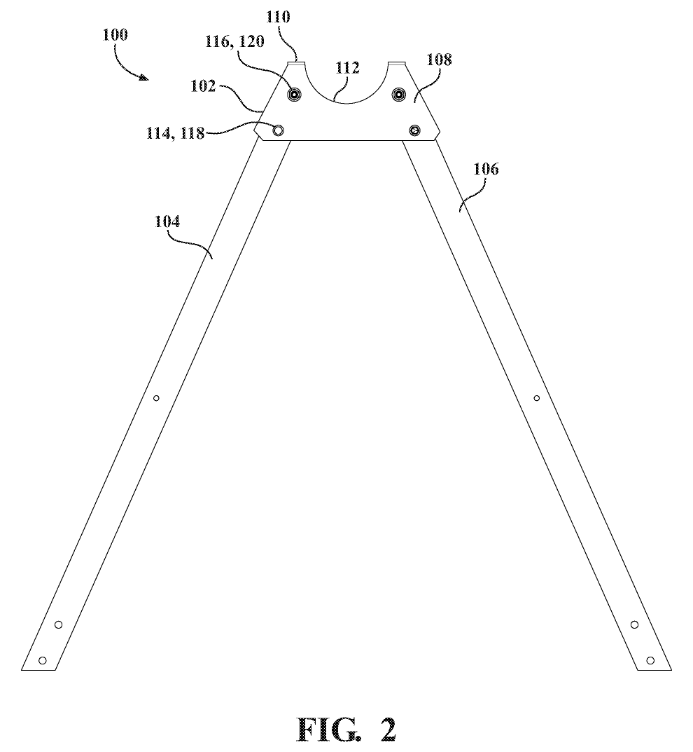

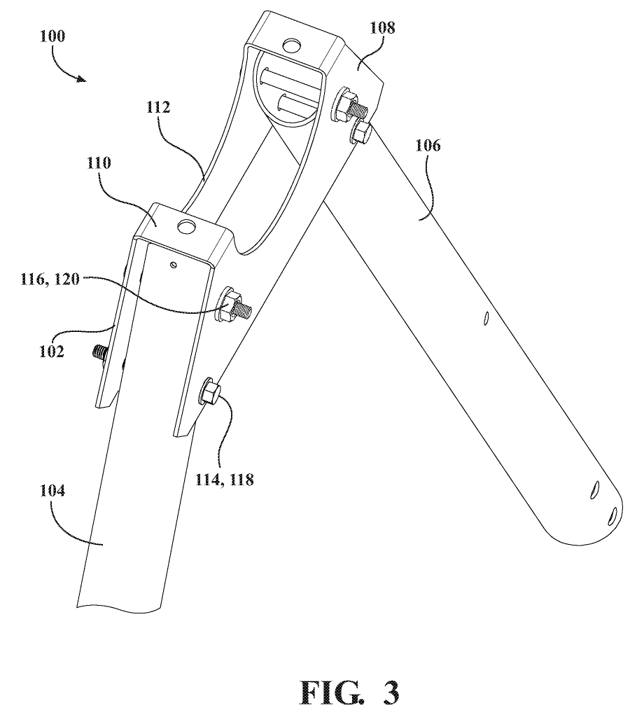

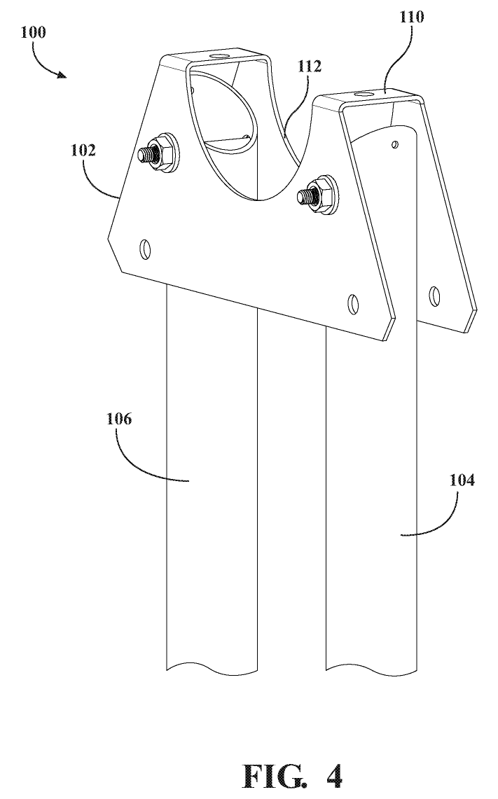

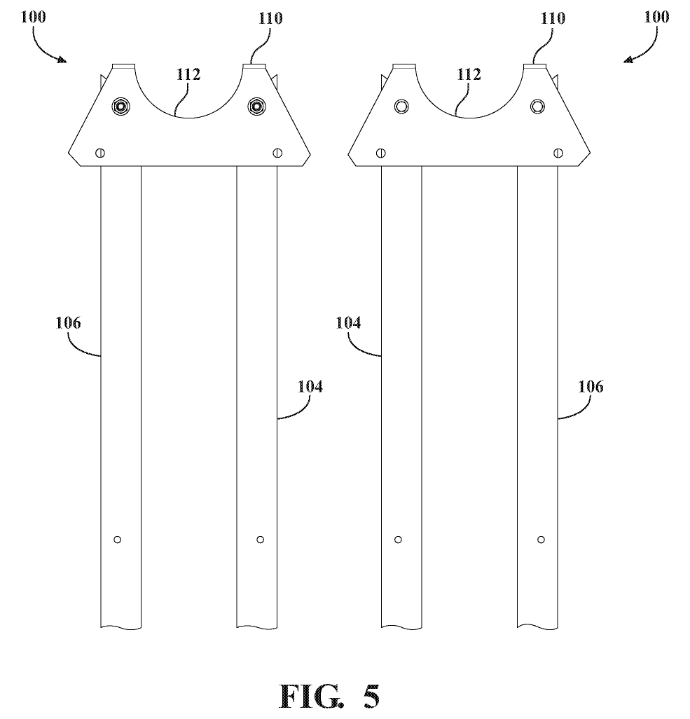

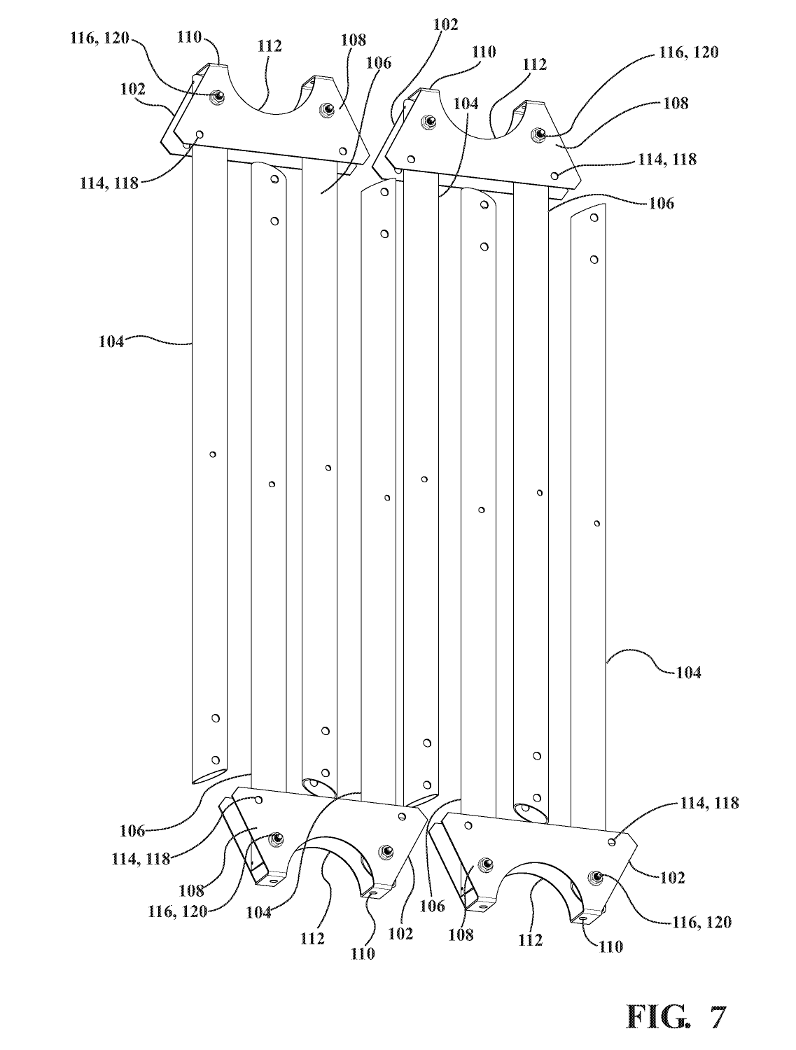

With reference to FIGS. 1-7, embodiments of a mounting bracket 102 may be formed as either a single piece through stamping and bending processes to create the apertures, cutout, and general shape, or assembled from two panels 108, such as a trapezoidal panel connected with fasteners. Each of the panels 108 may be defined by two generally parallel portions and two angled portions. The panels 108 may be connected to one another through a top wall 110, which may be integral to the single-piece construction or a separate component. The mounting bracket 102 can include a semicircular cutout 112 disposed in the top wall 110. The panels 108 may be configured to provide structural support while allowing for selective positioning of the first member 104 and second member 106 within the mounting bracket 102 and between deployed, folded, and extended configurations.

Each of the panels 108 may include two pairs of apertures. A top pair of apertures 114 and a bottom pair of apertures 116 may be formed in each panel 108. The aperture pairs 114, 116 may be configured to receive fasteners therethrough to secure the mounting bracket 102 to the first member 104 and second member 106, enabling selective positioning between the deployed, folded, and extended configurations through removal and reinsertion of the fasteners. The fasteners may include, but are not limited to, bolt and nut configurations that allow for secure attachment while maintaining the ability to be removed and reinserted as needed to adjust the assembly configuration. The specific type and size of the fasteners 120 may be selected based on load requirements and structural needs of the assembly, with the fasteners 120 being configured to maintain secure connections between components while allowing for selective removal during reconfiguration.

The fasteners may be inserted through an aperture of the top pair of apertures 114 or bottom pair of apertures 116 in a panel 108, through a corresponding aperture in either the first member 104 or second member 106, and through an aligned aperture in the opposing panel 108. Inserting the fasteners through the aperture of the top pair of apertures 114 and the corresponding apertures in the first member 104 or second member 106 provides for a pivoting attachment of the first member 104 and second member 106 to the panels 108 to facilitate pivoting the first member 104 and second member 106 to the deployed, folded, and extended positions. It should be understood that the fastener inserted through the aperture of the top pair of apertures 114 may provide a clamping force to the panels 108 to maintain the first member 104 and second member 106 in the deployed, folded, or extended positions. In certain embodiments it should be understood that the fastener inserted through the aperture of the bottom pair of apertures 116 may facilitate maintaining the first member 104 and second member 106 in the deployed, folded, or extended positions. This through-bolt configuration may secure the first member 104 and second member 106 to the mounting bracket 102 while allowing for selective removal of the fasteners 120 to enable reconfiguration between the deployed, folded, and extended positions. When the fasteners 120 are inserted through the aligned apertures, the first member 104 and second member 106 may be securely retained between the panels 108 of the mounting bracket 102 at the desired angle for the selected configuration.

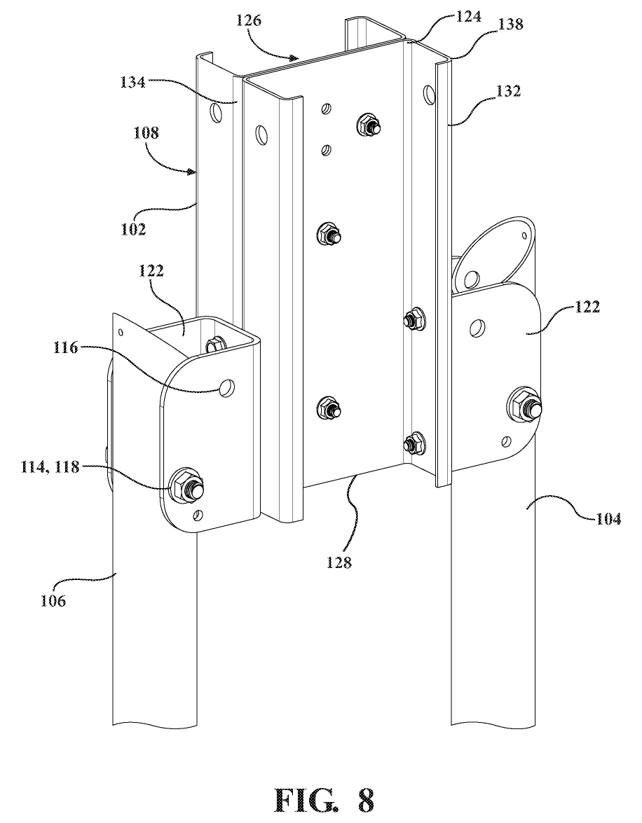

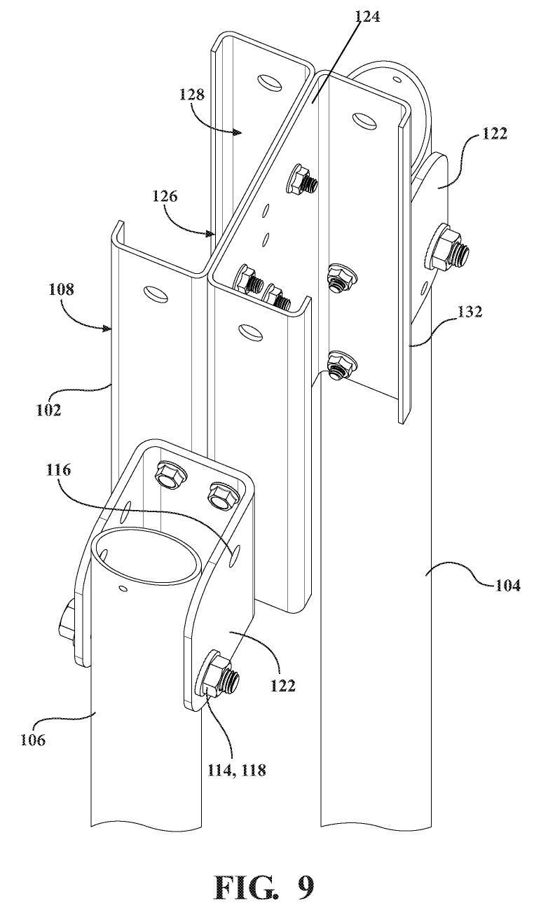

With reference to FIGS. 8-11, embodiments of the mounting bracket 102 may be formed from an I-beam configuration. The I-beam configuration of the mounting bracket 102 may include two attachment portions, with each attachment portion having a top pair of apertures 114 and a bottom pair of apertures 116. The aperture pairs 114, 116 may be configured to receive fasteners 120 therethrough to secure the mounting bracket 102 to the first member 104 and second member 106, enabling selective positioning between deployed, folded, and extended configurations through removal and reinsertion of the fasteners. The I-beam configuration can provide structural support while maintaining the ability to selectively position the first member 104 and second member 106 within the mounting bracket 102 through the aligned aperture pairs.

The mounting bracket 102 may be configured as an I-beam comprised of two C-shaped members 124, 126 positioned back-to-back. Each C-shaped member 124, 126 may include a center portion 128 and a pair of extending portions. The center portions 128 of the two C-shaped members 124, 126 may abut each other, while the pairs of extending portions 130 extend in opposite directions to form the pair of flanges of the I-beam 129. The C-shaped members 124, 126 may be coupled together using fasteners extending through apertures disposed in the center portions 128, providing a secure connection while maintaining the structural integrity of the I-beam configuration.

The channel members 122 may be coupled to the I-beam 129, with each first channel member coupled to one of the flanges 132 formed by the extending portions. Each first channel member 122 may include a spacer 134 and a pair of substantially parallel arms 138. The coupling between the first channel members 122 and the I-beam 129 may be achieved through coupling apertures 140 disposed in each flange 132 of the I-beam 129, coupling apertures 140 disposed in each first channel member 122, and coupling fasteners extending through the coupling apertures 140 to couple each first channel member 122 to one of the flanges 132. The coupling apertures 140 in each channel member 122 may be disposed in the spacer 134, while the coupling apertures 136 are disposed in the flanges 132 formed by the extending portions 130 of the I-beam 129. This coupling configuration provides secure attachment while allowing the first channel members 122 to be positioned at the appropriate locations along the flanges 132 for optimal structural support.

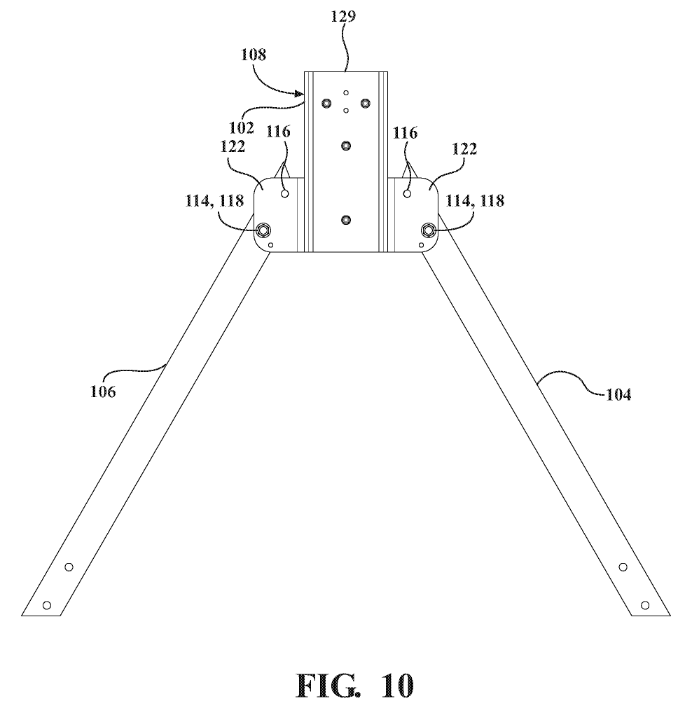

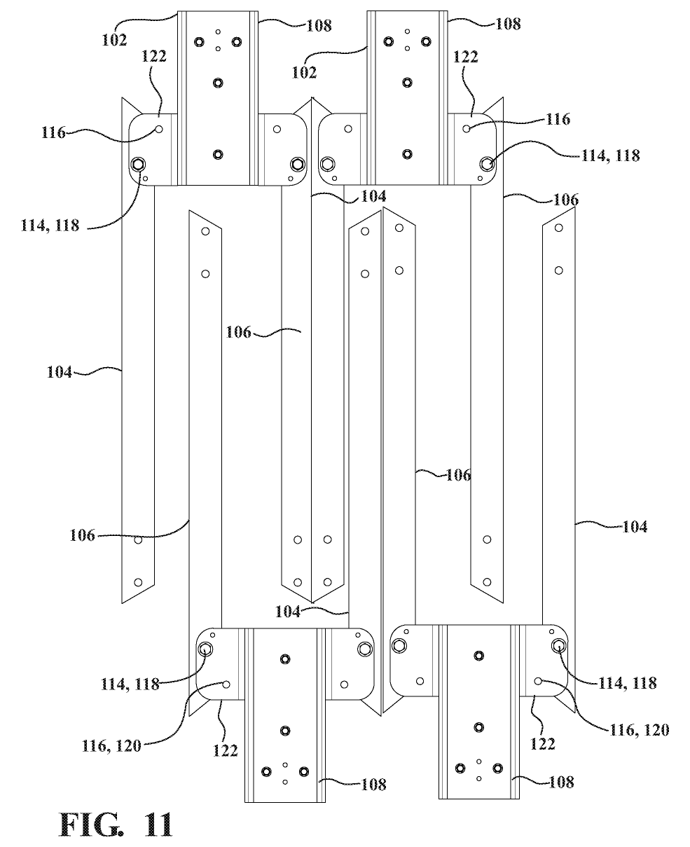

The plurality of first apertures 136 including the first rotational aperture 114 and the first fixation aperture 118 may be disposed in the substantially parallel arms 138 of each first channel member 122, as shown in FIGS. 8 and 10. These apertures 114, 118 may be configured to cooperate with corresponding second apertures 142 in the longitudinal members 104, 106 to enable selective rotation and fixation of the longitudinal members 104,106 relative to the mounting bracket 102. The first rotational aperture 114 may provide a pivot point for rotation of the longitudinal members 104, 106 between the folded, extended, and deployed configurations, while the first fixation aperture 118 may receive fasteners to secure the longitudinal members 104, 106 in the deployed configuration. As shown in FIG. 11, multiple A-frame assemblies 100 utilizing the I-beam configuration may be arranged in the folded configuration with adjacent assemblies oriented 180 degrees relative to each other. In this arrangement, the pairs of longitudinal members 104, 106 of adjacent A-frame assemblies may interdigitate, with the first channel members and I-beam mounting brackets 102 positioned to maximize packing density during shipping and storage. This interdigitated or interleaved arrangement significantly improves shipping efficiency by reducing the overall volume required to transport multiple A-frame assemblies.

The coupling between the channel members 122 and the I-beam 129 may enable a pivoting interface for the longitudinal members 104, 106. The spacer 134 of each first channel member 122 provides a distance between the substantially parallel arms 138 and the flanges of the I-beam 129, for the longitudinal members 104, 106 between the parallel arms 138. This configuration enables the longitudinal members 104, 106 to rotate freely about the first rotational aperture 114 while being constrained within the channel members 122 formed by the parallel arms 138, preventing lateral displacement during a configuration change. Coupling fasteners extending through the coupling apertures 136, 140 may be positioned at strategic locations along the length of each first channel member 122 to distribute loads evenly across the I-beam flanges 132, enhancing the overall structural integrity of the mounting bracket 102 while maintaining the selective positioning functionality required for the folded, extended, and deployed configurations.

In the extended configuration, where the longitudinal members 104, 106 are rotated outwardly until positioned substantially in line with one another, a linear arrangement is created that minimizes the perpendicular profile of the A-frame assembly 100. In this configuration, the first rotational aperture 114 continues to serve as the pivot point while selected fasteners are repositioned to maintain the extended angular relationship between the longitudinal members and the mounting bracket 102. The extended configuration demonstrates an alternative compact arrangement to the folded configuration, as shown in FIG. 11, providing flexibility in shipping and storage options based on container dimensions and stacking requirements. When multiple A-frame assemblies 100 are arranged in the folded configuration with the I-beam embodiment, the alternating 180-degree orientations allow the first channel members 122 of adjacent assemblies to nest alongside one another while the longitudinal members 104, 106 interdigitate in the spaces between adjacent mounting brackets 102, for an efficient packing density that reduces shipping volume requirements compared to rigid A-frame designs.

A modular construction utilizing identical C-shaped members 124, 126 may reduce tooling costs and minimize material waste during production, as manufacturers can produce a single component type in volume rather than maintaining separate fabrication processes for multiple distinct parts. The I-beam 129 configuration provides superior load distribution characteristics compared to panel-based designs, as the flanges 132 formed by the extending portions 130 distribute stresses across a wider surface area when supporting solar tracking equipment under wind loads and other environmental forces. Additionally, the channel 144 attachment system facilitates field maintenance and component replacement, as individual first channel members 122 can be inspected, serviced, or replaced without disassembling the entire I-beam structure.

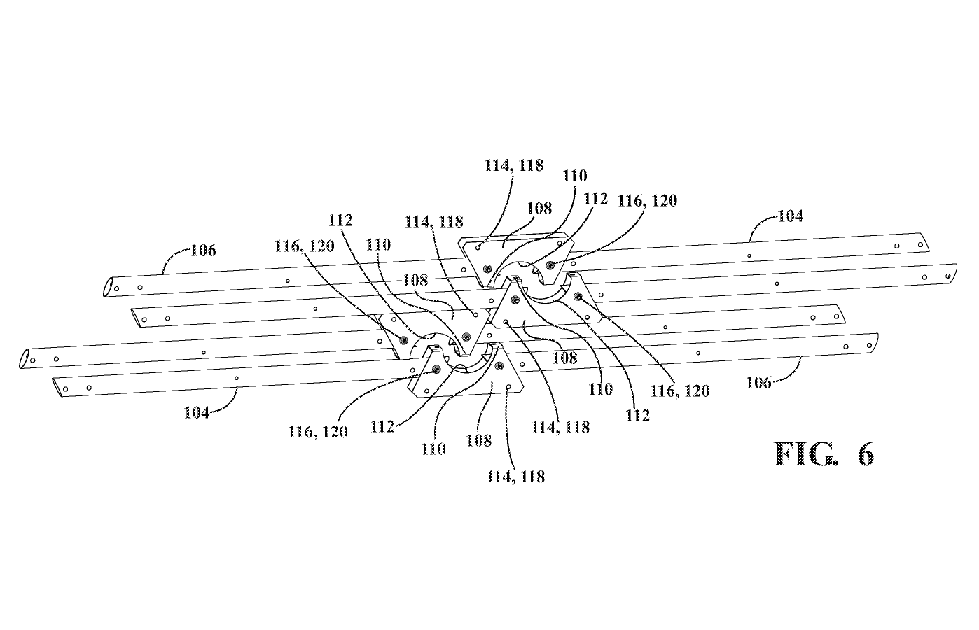

When the fasteners are removed from the mounting bracket 102, the first member 104 and second member 106 may be repositioned to achieve different angular orientations relative to the mounting bracket 102. In the deployed configuration as shown in FIGS. 1 and 6, the first member 104 and second member 106 may be positioned at predetermined angles to provide structural support.

By removing the lower fasteners, the first member 104 and second member 106 may be folded inward to achieve a more compact folded configuration with reduced overall profile where the first member 104 and second member 106 are disposed substantially parallel to one another. In this folded configuration, multiple A-frame assemblies 100 may be positioned in an overlapping arrangement, with adjacent assemblies oriented 180 degrees relative to one another such that the first member 104 and second member 106 of adjacent assemblies may be interleaved. This interleaved arrangement in the folded configuration enables a much higher packing and shipping density by allowing multiple A-frame assemblies 100 to be nested together in a compact stack.

In the extended configuration, the first member 104 and second member 106 may be rotated outwardly from the mounting bracket 102 until they are positioned substantially parallel to one another. This extended configuration may be achieved by removing either the upper or lower fasteners 120, depending on the specific components, allowing the first member 104 and second member 106 to be repositioned at their maximum outward angles. The removed fasteners may then be reinserted into the mounting bracket's plurality of holes to secure the members in the extended position while keeping all fasteners with the assembly. The extended configuration, like the folded configuration, enables higher packing and shipping density while providing an alternative positioning option for the A-frame assembly 100. In operation, the A-frame assembly 100 may be received in either a folded configuration or an extended configuration to maximize shipping density. When received in the folded configuration, the first member 104 and second member 106 may be positioned substantially parallel to one another, with the assembly 100 potentially interleaved with other assemblies oriented 180 degrees relative to each other. To reconfigure from the folded configuration to the deployed configuration, the first member 104 and second member 106 may be unfolded from their parallel position to achieve the desired operational angles relative to the mounting bracket 102.

When received in the extended configuration, the first member 104 and second member 106 may be positioned substantially parallel to one another in an outwardly rotated position. To reconfigure from the extended configuration to the deployed configuration, the first member 104 and second member 106 may be rotated inward to achieve the desired operational angles relative to the mounting bracket 102.

Once the desired operational angles are achieved for the deployed configuration, fasteners may be inserted through the aligned apertures of the panels 108. Specifically, fasteners may be inserted through both the top pair of apertures 114, passing through corresponding apertures in the first member 104 and second member 106, and through the aligned apertures in the opposing panel 108. The insertion of fasteners 120 through both the top and bottom aperture pairs secures the A-frame assembly 100 in its deployed configuration, ready for installation of solar tracking equipment.

### EXAMPLES

Example embodiments of the present technology are provided with reference to the several figures enclosed herewith.

### Example 1: Deployment Configuration

The A-frame assembly 100 may be assembled in its deployed configuration by securing the first member 104 and second member 106 to the mounting bracket 102 using fasteners 120 through both the top pair of apertures 114 and bottom pair of apertures 116. In this configuration, the first member 104 and second member 106 may be positioned at predetermined angles relative to the mounting bracket 102 to provide optimal structural support for solar tracking equipment.

The fasteners 120 may be inserted through the aligned apertures of the panels 108, passing through corresponding apertures in the first member 104 and second member 106. The deployed configuration maintains the A-frame assembly 100 in its operational position with the first member 104 and second member 106 forming a triangular support structure.

In the deployed configuration, the mounting bracket 102 may be oriented with its semicircular cutout 112 positioned to interface with solar tracking equipment. The panels 108 connected through the top wall 110 provide structural stability while the fasteners 120 secure the components in their operational positions.

### Example 2: Folded Configuration for Shipping

The A-frame assembly 100 may be converted to its folded configuration by removing the lower fasteners 120 from the bottom pair of apertures 116 while maintaining the fasteners 120 in the top pair of apertures 114. This selective removal allows the first member 104 and second member 106 to be folded inward until they are positioned substantially parallel to one another. The removed lower fasteners may then be reinserted through available apertures in the mounting bracket to secure the members in the folded position during shipping and storage, ensuring all fasteners remain with the assembly. This folded configuration allows for a much higher packing and shipping density.

In the folded configuration, multiple A-frame assemblies 100 may be arranged in an overlapping pattern with adjacent assemblies oriented 180 degrees relative to each other. This arrangement allows the first member 104 and second member 106 of adjacent assemblies to be interleaved, creating a compact stack that maximizes shipping density.

The folded configuration significantly reduces the overall profile of each A-frame assembly 100, allowing more units to be transported before reaching trailer volume limitations. The ability to maintain the top fasteners 120 while removing only the bottom fasteners 120 ensures the components remain connected during transport while achieving the desired compact arrangement.

### Example 3: Extended Configuration

The A-frame assembly 100 may be positioned in an extended configuration by removing selected fasteners 120 and rotating the first member 104 and second member 106 outwardly from the mounting bracket 102. In this configuration, the first member 104 and second member 106 may be positioned until they are substantially parallel to one another, but oriented outward rather than inward as in the folded configuration.

The extended configuration may be achieved by removing either the upper or lower fasteners 120, depending on the specific components and desired positioning. This configuration provides an alternative arrangement that maintains the connection between components while allowing for efficient storage and transport options.

The ability to achieve multiple configurations through selective removal and reinsertion of fasteners 120 demonstrates the versatility of the A-frame assembly 100. The extended configuration, like the folded configuration, enables improved shipping density while providing flexibility in how the assemblies may be arranged during transport and storage.

### Example 4: I-Beam Construction with Channel Member Attachment

The A-frame assembly 100 may be configured with a mounting bracket 102 formed from an I-beam construction comprised of two C-shaped members 124, 126 positioned back-to-back, as shown in FIGS. 8-11. Each C-shaped member 124, 126 may include a center portion 128 and a pair of extending portions 130. The center portions 128 of the two C-shaped members 124, 126 may abut each other, while the pairs of extending portions 130 extend in opposite directions to form the flanges of the I-beam 129.

The C-shaped members 124, 126 may be coupled together using fasteners extending through apertures disposed in the center portions 128, creating a rigid I-beam structure that provides enhanced structural integrity while maintaining manufacturing flexibility. This construction method allows the I-beam 129 to be assembled from two identical C-shaped components, simplifying manufacturing and inventory management.

A pair of first channel members 122 may be coupled to the I-beam 129, with each first channel member 122 attached to one of the flanges formed by the extending portions 130. Each first channel member 122 may include a spacer and a pair of substantially parallel arms. The coupling between each first channel member 122 and the I-beam 129 may be achieved through coupling apertures 136 disposed in each flange of the I-beam 129, and coupling apertures.

The plurality of first apertures including the first rotational aperture 114 and the first fixation aperture 118 may be disposed in the substantially parallel arms of each first channel member 122, as shown in FIGS. 8 and 10. These apertures 114, 118 cooperate with corresponding second apertures in the longitudinal members 104, 106 to enable selective rotation and fixation between the folded, extended, and deployed configurations.

Multiple A-frame assemblies 100 utilizing the I-beam configuration may be arranged in the folded configuration with adjacent assemblies oriented 180 degrees relative to each other. In this interleaved arrangement, the pairs of longitudinal members 104, 106 of adjacent A-frame assemblies interdigitate, maximizing packing density during shipping and storage while maintaining all structural components in a protected configuration. This I-beam construction provides comparable shipping efficiency to the panel embodiment while offering enhanced structural rigidity and simplified manufacturing through the use of identical C-shaped components.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in

the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods may be made within the scope of the present technology, with substantially similar results.

What is claimed is:

1. An A-frame assembly for a solar tracking system, comprising:
a mounting bracket including an I-beam and a pair of first channel members, the I-beam having a pair of flanges spaced apart, each first channel member coupled to one of the flanges, each first channel member including a plurality of first apertures, the plurality of first apertures including a first rotational aperture and a first fixation aperture;
a pair of longitudinal members, each longitudinal member including a first end, a second end, and a plurality of second apertures adjacent the first end, the plurality of second apertures including a second rotational aperture and a second fixation aperture;
a plurality of fasteners configured to cooperate with the plurality of first apertures and the plurality of second apertures to couple the pair of longitudinal members to the mounting bracket;
wherein the pair of longitudinal members are coupled to the mounting bracket using the plurality of fasteners in cooperation the first rotational aperture and the second rotational aperture, where the pair of longitudinal members are configured to be selectively rotated between:
a folded configuration where the pair of longitudinal members are positioned substantially parallel to one another;
an extended configuration where the pair of longitudinal members are positioned in line with one another; and
a deployed configuration where the pair of longitudinal members are positioned at a predetermined angle between the folded configuration and the extended configuration, the deployed configuration allowing the plurality of fasteners to cooperate with the first fixation aperture and the second fixation aperture to fixedly couple the pair of longitudinal members relative to the mounting bracket.

2. The A-frame assembly of claim 1, wherein the I-beam is comprised of two C-shaped members positioned back-to-back.

3. The A-frame assembly of claim 2, wherein each C-shaped member includes a center portion and a pair of extending portions.

4. The A-frame assembly of claim 3, wherein the center portions of the two C-shaped members abut each other and the pairs of extending portions extend in opposite directions to form the pair of flanges.

5. The A-frame assembly of claim 3, wherein the C-shaped members are coupled together using fasteners extending through apertures disposed in the center portions.

6. The A-frame assembly of claim 1, wherein each first channel member includes a spacer and a pair of substantially parallel arms extending from the spacer.

7. The A-frame assembly of claim 1, where the plurality of first apertures including the first rotational aperture and the first fixation aperture are disposed in substantially parallel arms of each first channel member.

8. The A-frame assembly of claim 1, wherein the plurality of fasteners includes bolt and nut configurations.

9. The A-frame assembly of claim 1, wherein the plurality of fasteners is configured to be inserted through an aperture in an attachment portion, through a corresponding aperture in either the first member or second member, and through an aligned aperture in an opposing rectangular attachment portion.

10. The A-frame assembly of claim 1, wherein the plurality of fasteners inserted through the first fixation apertures maintain the first member and second member in the deployed configuration.

11. The A-frame assembly of claim 1, wherein the folded configuration is achieved by removing lower fasteners from the first fixation apertures while maintaining fasteners in the first rotational apertures.

12. The A-frame assembly of claim 11, wherein the removed lower fasteners are configured to be reinserted through available apertures in the mounting bracket to secure the first member and second member in the folded configuration.

13. The A-frame assembly of claim 1, wherein multiple A-frame assemblies in the folded configuration are configured to be arranged in an overlapping pattern with adjacent assemblies oriented 180 degrees relative to each other.

14. The A-frame assembly of claim 13, wherein the first member and second member of adjacent assemblies in the folded configuration are configured to be interleaved.

15. The A-frame assembly of claim 1, wherein the extended configuration is achieved by removing selected fasteners and rotating the first member and second member outwardly from the mounting bracket.

16. The A-frame assembly of claim 1, wherein the mounting bracket is formed as a unitary I-beam through stamping and bending processes.

17. The A-frame assembly of claim 1, wherein the mounting bracket is configured to support solar tracking equipment.

18. A set of A-frame assemblies for a solar tracking system, comprising:
a plurality of A-frame assemblies according to claim 1;
wherein the A-frame assemblies are in one of the folded configuration and the extended configuration.

19. A container of a set of A-frame assemblies for a solar tracking system, comprising:
a container including the set of A-frame assemblies according to claim 19.

20. A set of A-frame assemblies for a solar tracking system, comprising:
a plurality of A-frame assemblies according to claim 1;
wherein the A-frame assemblies are in the folded configuration, adjacent A-frame assemblies are positioned 180 degrees relative to each other, and the pairs of longitudinal members of adjacent A-frame assemblies interdigitate.

21. A set of A-frame assemblies for a solar tracking system, comprising:
a plurality of A-frame assemblies according to claim 1;
wherein the A-frame assemblies are in the extended configuration and the pairs of longitudinal members of adjacent A-frame assemblies are parallel with each other.

22. A solar tracking support system comprising:
a plurality of A-frame assemblies, each A-frame assembly including:
a mounting bracket configured as an I-beam including a pair of attachment portions spaced apart, each rectangular attachment portion including a plurality of first apertures, the plurality of first apertures including a first rotational aperture and a first fixation aperture;
a first tubular member positioned adjacent an exterior surface of one panel and including a first member top aperture and a first member bottom aperture, the first member top aperture aligned with the top pair of bracket apertures and the first member bottom aperture aligned with the bottom pair of bracket apertures of the panel;
a second tubular member positioned adjacent an exterior surface of the other of the two panels and including a second member top aperture and a second member bottom aperture, the second member top aperture aligned with the top pair of bracket apertures and the second member bottom aperture aligned with the bottom pair of bracket apertures of the panel,
the first tubular member and second tubular member positioned on opposite sides of the mounting bracket;
a plurality of fasteners comprising a bolt and nut configuration, each fastener extending through a bracket aperture in one of the panels, through a corresponding member aperture in an adjacent one of the first tubular member or second tubular member, and through an aligned bracket aperture in an opposing trapezoidal panel, and a pivot axis about which the first tubular member and second tubular member rotate, the fasteners inserted through the bottom pair of bracket apertures and the first member bottom aperture and second member bottom aperture providing structural reinforcement in a deployed configuration;
the first tubular member and second tubular member being selectively positionable in the deployed configuration with the first tubular member and second tubular member positioned at predetermined angles relative to the mounting bracket to form an A-shaped support structure, and a folded configuration;
wherein, the plurality of A-frame assemblies in the folded configuration being arranged in an overlapping pattern with adjacent A-frame assemblies oriented 180 degrees relative to each other, the first tubular member and second tubular member of each assembly being interleaved with the first tubular member and second tubular member of an adjacent assembly such that the first tubular member and second tubular member of a first assembly are positioned between the first tubular member and second tubular member of an adjacent second assembly with the mounting brackets of the first and second assemblies oriented in opposite directions.
